(19) United States
(12) Patent Application Publication
(10) Pub. No.: US 2011/0010763 A1
(43) Pub. Date: Jan. 13, 2011

(54) TOOL AND METHOD FOR GENERATING PASSWORDS

(76) Inventor: CHARLES E. BEARDSLEE, NATALIA, TX (US)

Correspondence Address: MCKEE, VOORHEES & SEASE, P.L.C., 801 GRAND AVENUE, SUITE 3200, DES MOINES, IA, 50309-2721, US

(21) Appl. No.: 12/730,497

(22) Filed: Mar. 24, 2010

Related U.S. Application Data
(60) Provisional application No. 61/225,062, filed on Jul. 13, 2009.

(51) Int. Cl. H04L 9/32; G06F 21/00

(52) U.S. Cl. 726/6

(57) ABSTRACT

A grid is provided for creating secure and confidential passwords for use in sign-in procedures on electronic user accounts. The tool includes a grid having multiple rows and columns defining cells, with each cell having randomly assigned keyboard characters, such as letters, numbers, and symbols. A user creates a password by selecting a starting cell, and progressing in a user-selected pattern through a pre-selected number of cells. Multiple unique grids may be provided in hard copy or digital form for use in creating multiple passwords which may be created using the same or different starting cells and/or patterns.

### CROSS-REFERENCE TO RELATED APPLICATIONS

This application claims priority under 35 U.S.C. §119 of a provisional application Ser. No. 61/225,062 filed Jul. 13, 2009, which application is hereby incorporated by reference in its entirety.

### BACKGROUND OF THE INVENTION

Passwords are often required to gain access to electronic personal accounts and information, such as on-line or internet accounts used to make purchases and payments, or to check the status of a transaction, activity or event. The use of such personal identification numbers (PINs), passwords or passphrases are commonly required to withdraw money from an ATM, using a debit or credit card, log into a computer or e-mail, to do on-line banking or shopping, and other numerous and various activities. Different accounts often require different passwords of varying length and limitations, such as alpha-numeric combinations, special characters, capitalizations, and the like. Keeping track of numerous passwords may be frustrating and difficult for an individual. Furthermore, choosing strong passwords that are difficult to crack or guess by an unauthorized person further complicates the password selection or generation process. Ideally, the goal is to choose a password that eliminates identity, information, or monetary theft, or at a minimum, makes the risk of such theft extremely low.

In the cyber world, verification or authentication that a person is authorized to access an account is very important, with passwords being a common means for such authentication. However, insecure or inadequate passwords jeopardize such verification efforts, and make it easier for hackers, viruses, and worms to exploit systems by guessing or cracking weak passwords. For example, many people use passwords based on personal information which is easy to remember. However, such passwords are easier to guess or crack. While intentional misspelling of words may offer some protection against dictionary attacks, such strategy is not fool proof. The best defense to assure password security is to use a combination of numbers, special characters, and upper and lower case letters. Also, longer passwords are more secure than shorter passwords. Furthermore, even with a strong password, it is highly recommended that the same password not be used for every system or program, but rather, unique passwords should be developed for each personal account.

Even when all recommendations are adopted, it is common to forget a password, or confuse which password goes with which account. Some programs automatically lock out a user after a specified number of failed password attempts, and then require the user to obtain a new password. Such lock outs increase aggravations for the user, wastes time and creates undesirable delays, such as online payment of a bill within a specific deadline.

Therefore, a primary objective of the present invention is the provision of a tool and method for creating strong, unique passwords for use in accessing personal accounts over the internet.

Another objective of the present invention is the provision of a method for generating electronic account passwords using a spreadsheet of randomly assigned keyboard characters and a user-selected pattern for choosing characters in the cells of the spreadsheet.

A further objective of the present invention is the provision of a password tool which can be in either hard copy or digital form.

Another objective of the present invention is the provision of a booklet having multiple pages, with each page having a unique matrix or grid of characters from which the user can form a password.

Another objective of the present invention is the provision of a digital set of pages, with each page having a unique grid of characters from which a user can form passwords.

Still another objective of the present invention is the provision of a spreadsheet having a plurality of rows and columns forming a grid, with each cell having a keyboard character from which a user-selected pattern creates a password.

A further objective of the present invention is the provision of a password creation tool and method which is confidential to the user.

Another objective of the present invention is the provision of a password creation tool and method which cannot be broken by a hacker in a reasonably expeditious manner.

Yet another objective of the present invention is the provision of a password creation tool and method which substantially eliminates identity, information, or monetary theft.

Yet another objective of the present invention is the provision of a password creation tool and method which is virtually hack-proof.

Still another objective of the present invention is the provision of a password creation tool and method which utilizes a plurality of keyboard characters, including upper and lower case letters, numerals, and/or non alpha-numeric characters.

These and other objectives will be apparent from the following description of the invention.

### SUMMARY OF THE INVENTION

The password creating tool of the present invention generally comprises one or more grids having multiple rows and multiple columns defining a plurality of cells. Each cell contains a character from a conventional keyboard, such as upper and lower case letters, numerals, and/or non alpha-numeric symbols. The characters are randomly assigned to the cells, so that each grid is unique. A user creates a password by selecting a starting cell, and then progressing in a user-selected pattern through a selected number of cells. The grids may be in hard copy form, such as a booklet, or in digital form assessable via a computer, cell phone, or other PDA. Multiple passwords may be created using the same or different grids, using the same or different patterns, and using the same or different starting cells.

### BRIEF DESCRIPTION OF THE DRAWINGS

FIGS. 1-4 are representative examples of different spreadsheet grids as they appear to a user for generating passwords according to the present invention.

FIGS. 5-8 are examples of additional spreadsheet grids with various user-selected patterns highlighted to show potential passwords created from the grids.

FIG. 9 shows a series of unique grids which may be presented to a user in an electronic format or booklet format for use in generating one or more passwords.

### DETAILED DESCRIPTION OF THE PREFERRED EMBODIMENT

The present invention is directed to a tool for creating or generating passwords to provide user access to personal accounts over the internet. This tool is one or more spreadsheets having a grid of multiple rows and columns defining a plurality of cells. Each cell contains a single keyboard character, such as letters, numbers, and special characters or symbols typically found on a keyboard, such as punctuation marks, mathematical symbols, and the like. Preferably, the letters include both capital letters and lower case letters. The cell characters are randomly generated using commercially available software, such as the standard functions in an Excel software program.

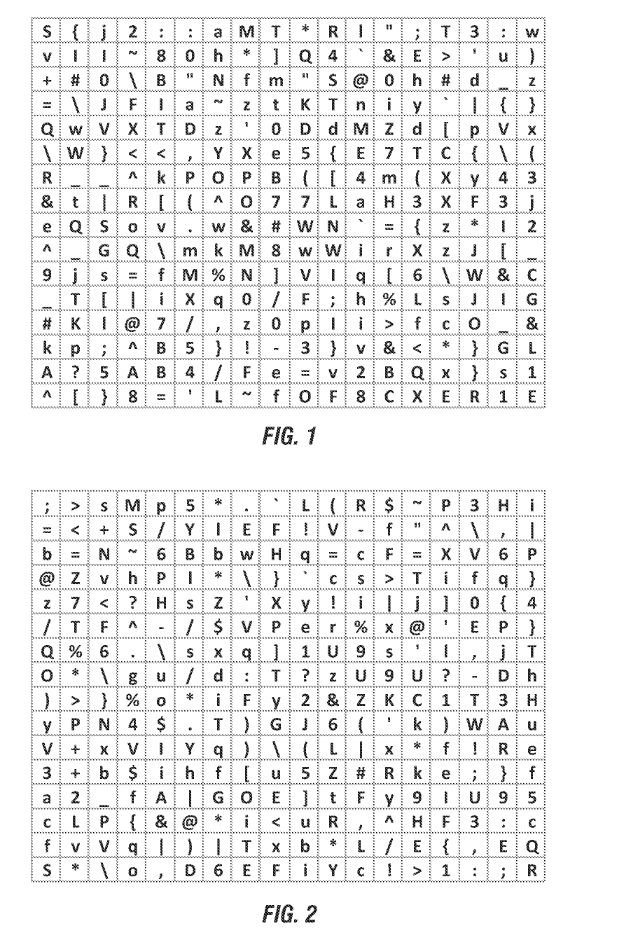

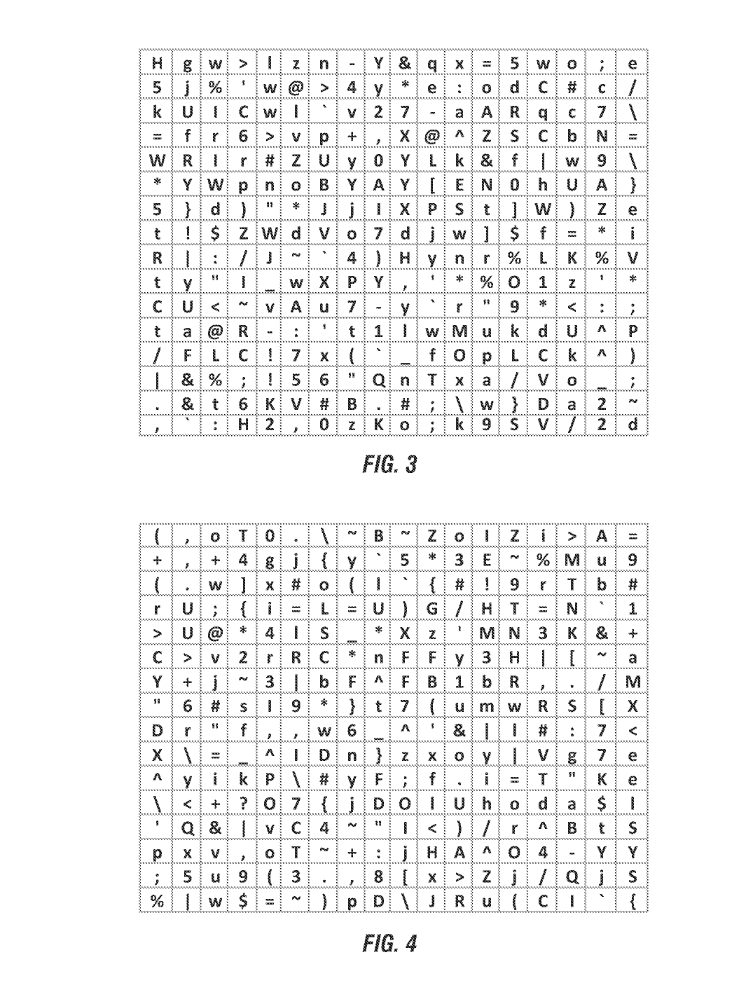

For example, in FIGS. 1-8, eight different grids are shown, each having 18 columns and 16 rows. It is understood that the number of rows and columns may be changed without departing from the scope of the invention. It is also understood that the characters in the cells may be limited to lower case letters and numbers, without any special symbols, for example if a password is limited to alpha/numeric characters. However, the inclusion of both upper and lower case letters, as well as punctuation marks and mathematical notations provide enhanced security against potential hackers.

The spreadsheets may be maintained in a hard copy printed form or stored in digital form on a computer or other electronic device. If multiple spreadsheets are printed, they may be assembled in a booklet, preferably with one spreadsheet per page. Since the cells contain randomly assigned characters, each spreadsheet or grid is unique. Thus, no two booklets are the same, which virtually eliminates any possibility of a software algorithm being created to crack the passwords which a user creates using the books or spreadsheets.

To create a password using the spreadsheets, a user selects a starting cell and a pattern in which to proceed through the cells to sequence a selected number of characters. The pattern may move horizontally, vertically, or diagonally. For example, a pattern may be in the form of a letter, such as an “L”, a “U”, an inverted “U”, a “Z”, a reverse “L”, a backward “Z”, or any other letter or single digit number. As another example, the pattern may be a shape, such as a square or rectangle, and may progress clockwise or counterclockwise. Thus, the user selects in which cell to start the pattern, and in which direction the pattern will progress. When choosing multiple passwords for different accounts, the user may use the same pattern on different grids, or may use different patterns on the same grid.

For example, FIG. 5 shows a password using an “L” pattern. The password may begin at the top of the “L”, at column 5, row 5, and progress downwardly and to the right, or alternatively, may start at column 9, row 10, and progress to the left and then upwardly to finish at column 5, row 5.

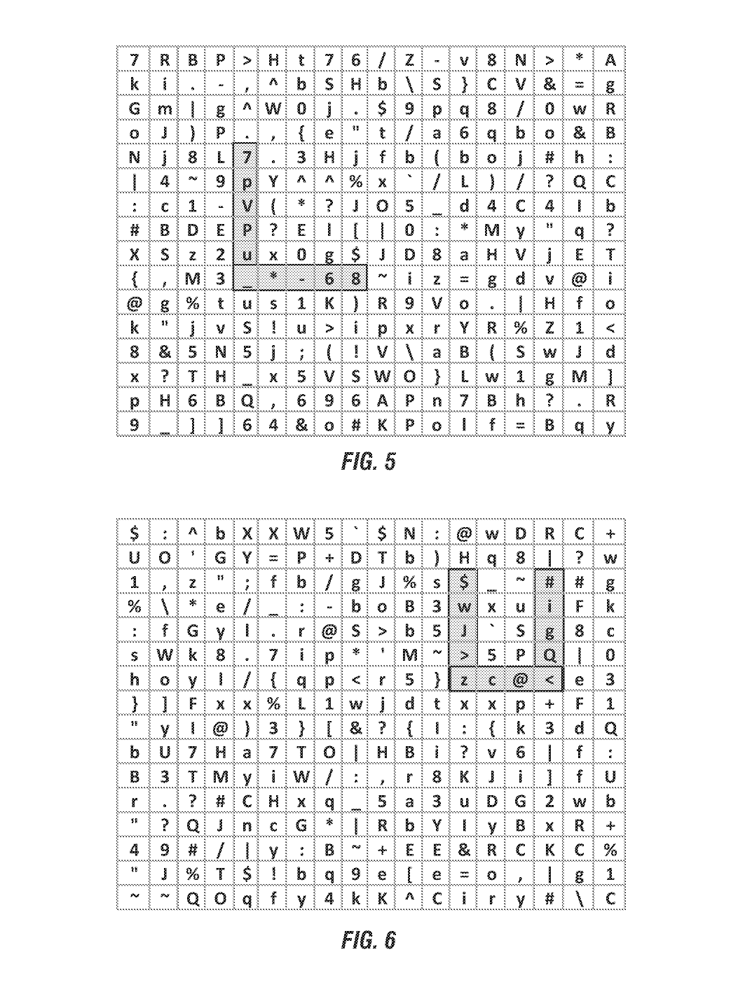

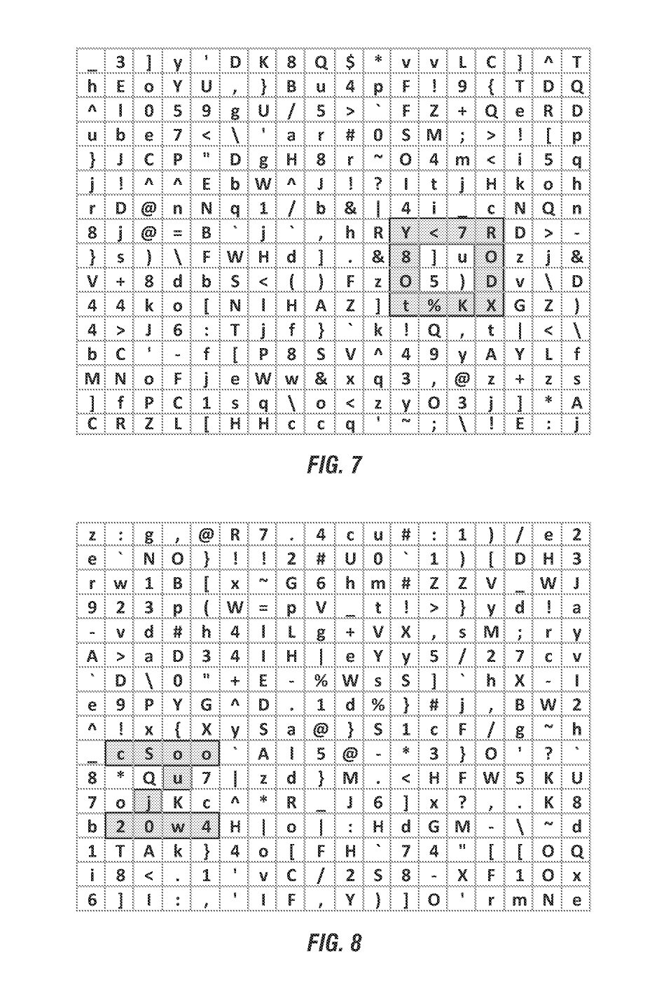

FIG. 6 shows another example wherein the password is formed by a “U” shaped pattern, beginning at either column 13, row 3, or column 16, row 3. Similarly, FIG. 7 shows a highlighted square pattern for creating a password, which may start at any cell of the square, such as the upper left corner, upper right corner, lower left corner, or lower right corner, and then progress clockwise or counter clockwise. A “Z” shaped pattern is highlighted in FIG. 8, with the password being started at either the upper left end of the “Z” (column 2, row 10), or the lower end of the “Z” (column 5, row 13).

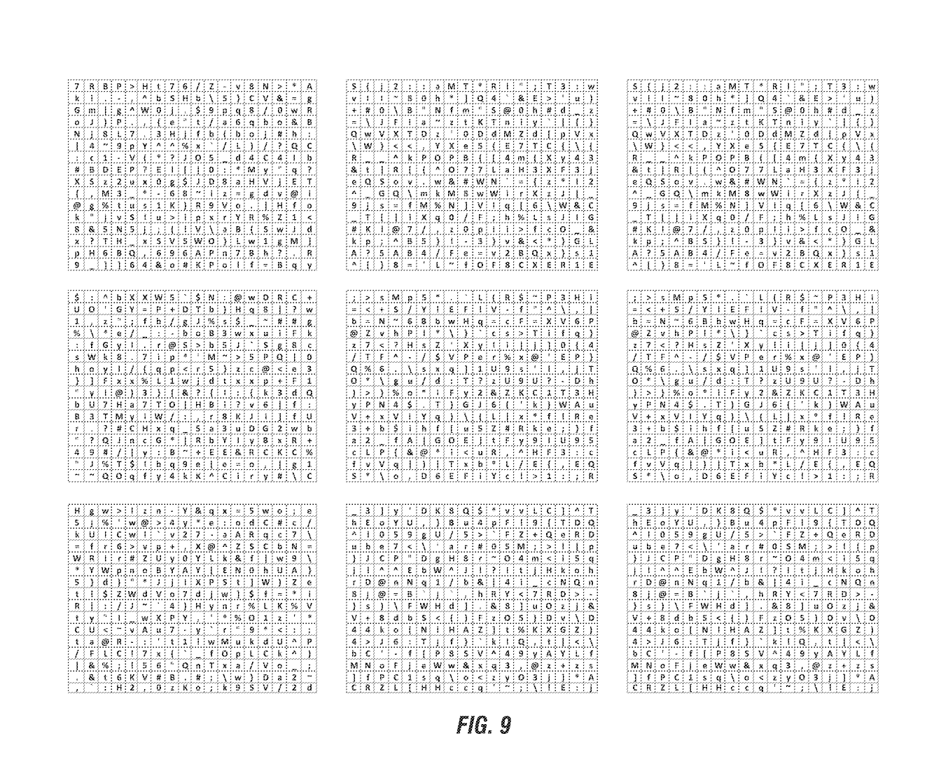

As an alternative to a hard copy grid page or booklet, one or more grid pages may be presented to a user via a computer, cell phone, or PDA. For example, FIG. 9 illustrates a screen shot of nine unique grids which are opened when a user clicks in a password field of a software application. When the user sees this panel or display of FIG. 9, they can choose one of the grids, which will then be enlarged, while the other grids are eliminated or hidden from the display. The user then highlights their selected password pattern, and with a click, the selected password is inserted into the password field of the software application to complete the sign-in process. Alternatively, the highlighted password can be copied and pasted into the password field for the sign-in process.

Ideally, the user should use a different password for each account. Different passwords may be generated using different grids, or different patterns on the same grid, or different starting points, or any combination of these variations.

Even if the spreadsheets are not maintained confidential, as long as the user has not identified the pattern or the starting point on the grid, it would be very difficult for someone else to crack or guess the password. Thus, the user only needs to remember which grid is used for a particular account, the pattern, and the starting point on the grid.

Thus, the tool and method of the present invention provides a secure password, while eliminating the need to write the password for future reference.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A tool for creating passwords to access personal accounts, comprising:
a grid having multiple rows and multiple columns defining cells at the intersections of each row and column;
a single keyboard character in each cell, the characters including letters, numbers and symbols; and
the characters being randomly assigned to the cells;
whereby a user creates a password by progressing in a user-selected pattern through a pre-selected number of cells starting at a user-selected cell.

2. The tool of claim 1 wherein the grid is in hard copy form.

3. The tool of claim 1 wherein the grid is in digital form.

4. The tool of claim 1 further comprising multiple grids each having cells with different randomly assigned cell characters for creating multiple passwords using different grids.

5. The tool of claim 4 wherein each of the multiple grids is unique.

6. The tool of claim 4 wherein the grids are collected in a booklet.

7. The tool of claim 4 wherein the grids are accessible to the user through the Internet or other software stored electronically.

8. The tool of claim 1 wherein the grid is accessed by the user on the Internet or other software stored electronically .

9. The tool of claim 1 wherein multiple passwords are created on the grid by using different patterns.

10. The tool of claim 1 wherein multiple passwords are created on the grid by using different starting cells.

11. A method for generating electronic account passwords, comprising:
providing a spreadsheet having a plurality of cells;
randomly assigning single keyboard characters to the cells, the characters including letters, numbers and special characters;
choosing a starting cell;
selecting a pattern for moving through the cells;
using the characters in the cells of the pattern as the password.

12. The method of claim 11 further comprising selecting a second pattern to create a second password.

13. The method of claim 11 further comprising choosing a second starting cell to create a second password.

14. The method of claim 11 further comprising providing a second spreadsheet having a second set of randomly assigned character cells, and using the starting cell and the selected pattern for moving through the cells of the second spreadsheet to identify characters to create a second password.

15. The method of claim 11 further comprising creating a second password by choosing a different starting cell, and/or selecting a different pattern for moving through the cells, and then using the corresponding cell characters for the second password.

16. The method of claim 11 wherein the spreadsheet is provided in hard copy form.

17. The method of claim 11 wherein the spreadsheet is provided in digital form.

18. The method of claim 11 wherein a user selects the spreadsheet from a plurality of spreadsheets.

19. The method of claim 18 wherein the plurality of spreadsheets are contained in a booklet.

20. The method of claim 18 wherein the plurality of spreadsheets are accessed through the Internet or other software stored electronically.
